(19) United States
(12) Patent Application Publication
(10) Pub. No.: US 2026/0273940 A1
(43) Pub. Date: Sep. 17, 2026

(54) Method Of Cleaning Liquid Ejection Head And Liquid Ejection Apparatus

(71) Applicant: SEIKO EPSON CORPORATION, Tokyo (JP)

(72) Inventors: Seiji IZUO, Shiojiri (JP); Tomohiro SAYAMA, Matsumoto (JP)

(21) Appl. No.: 19/563,426

(22) Filed: Mar. 11, 2026

(30) Foreign Application Priority Data
Mar. 12, 2025 (JP) 2025-039175

(51) Int. Cl. B41J 2/165; B41J 2/045; B41J 2/14

(52) U.S. Cl. CPC B41J 2/16508; B41J 2/04541; B41J 2/04581; B41J 2/04588; B41J 2/04596; B41J 2/14233; B41J 2002/16594; B41P 2235/14; B41P 2235/27

(57) ABSTRACT

A method of cleaning a liquid ejection head include filling an inside of a cap disposed to face an ejection surface of a nozzle plate with the liquid by driving a first piezoelectric element stacked on a diaphragm constituting a part of a pressure chamber communicating with a plurality of nozzle to eject the liquid from the nozzle, introducing air into the nozzle by driving the first piezoelectric element with a second drive signal different from the first drive signal after the filling, bringing the ejection surface into contact with the liquid in the cap after the filling, transmitting an ultrasonic wave to the liquid in the cap by driving a second piezoelectric element provided to the cap with a third drive signal after the introducing, and sucking the liquid in the cap by driving a suction pump configured to suck the liquid in the cap after the bringing.

The present application is based on, and claims priority from JP Application Serial Number 2025-039175, filed Mar. 12, 2025, the disclosure of which is hereby incorporated by reference herein in its entirety.

### BACKGROUND

### 1. Technical Field

The present disclosure relates to a technique of a method of cleaning a liquid ejection head and a liquid ejection apparatus.

### 2. Related Art

In the past, a technique of removing foreign matter such as thickened ink or solidified ink from a nozzle of a liquid ejection head has been known (JP-A-2002-361908). In the liquid ejection head, a vibration of a piezoelectric element is propagated to a diaphragm constituting a part of a pressure chamber to change the volume of the pressure chamber to thereby eject ink contained in the pressure chamber from the nozzle communicating with the pressure chamber. In the related art, a nozzle surface of the liquid ejection head provided with a nozzle opening is sealed by a cap in a state where the ink is stored in a sealing hollow portion of the cap, and the piezoelectric element is vibrated at a frequency higher than a driving frequency at which the ink is ejected from the nozzle. As a result, cavitation is generated in the ink contained in the sealed space extending from the pressure chamber to the sealing hollow portion of the cap via the nozzle, and the foreign matter adhering to the nozzle is separated with a shock wave generated by the cavitation. Further, the foreign matter is removed by sucking the ink in the sealing hollow portion of the cap after the foreign matter is separated from the nozzle.

JP-A-2002-361908 is an example of the related art.

In the related art, the sealing hollow portion of the cap and the pressure chamber communicate with each other via the ink. Therefore, the impact pressure of the cavitation generated in the cap when the foreign matter is separated from the nozzle propagates to the pressure chamber through the ink, and high pressure is applied to the piezoelectric element and the diaphragm in some cases. There is a possibility that this damages the piezoelectric element and the diaphragm.

### SUMMARY

(1) According to an aspect of the present disclosure, a method of cleaning a liquid ejection head is provided. The method of cleaning a liquid ejection head having a nozzle plate provided with a plurality of nozzles configured to eject a liquid, the method includes: a first step of filling an inside of a cap disposed to face a ejection surface of the nozzle plate provided with a nozzle opening with the liquid by driving a first piezoelectric element stacked on a diaphragm constituting a part of a pressure chamber communicating with the nozzle to eject the liquid from the nozzle; a second step of introducing air into the nozzle by driving the first piezoelectric element with a second drive signal different from the first drive signal after the first step; a third step of bringing the ejection surface into contact with the liquid in the cap after the second step; a fourth step of transmitting an ultrasonic wave to the liquid in the cap by driving a second piezoelectric element provided to the cap with a third drive signal after the third step; and a fifth step of sucking the liquid in the cap by driving a suction pump configured to suck the liquid in the cap after the fourth step.
(2) According to another aspect of the present disclosure, there is provided a liquid ejection apparatus. The liquid ejection apparatus includes: a liquid ejection head including a nozzle plate provided with a plurality of nozzles each configured to eject a liquid, a pressure chamber communicating with the nozzle, a diaphragm constituting a part of the pressure chamber, and a first piezoelectric element stacked on the diaphragm; a cap disposed to face a ejection surface of the nozzle plate provided with a nozzle opening; a second piezoelectric element provided to the cap and configured to transmit an ultrasonic wave to the liquid in the cap; a suction pump configured to suck the liquid in the cap; and a controller configured to control drive of the liquid ejection apparatus, wherein the controller is configured to execute, in this order, first processing of filling an inside of the cap with the liquid by driving the first piezoelectric element with a first drive signal to eject the liquid from the nozzle, second processing of introducing air into the nozzle by driving the first piezoelectric element with a second drive signal different from the first drive signal, third processing of bringing the ejection surface into contact with the liquid in the cap, fourth processing of transmitting the ultrasonic wave to the liquid in the cap by driving the second piezoelectric element with a third drive signal, and fifth processing of sucking the liquid in the cap by driving the suction pump.

### BRIEF DESCRIPTION OF THE DRAWINGS

FIG. 1 is a diagram illustrating a schematic configuration of a liquid ejection apparatus.

FIG. 2 shows a detailed configuration of the liquid ejection apparatus.

FIG. 3 is a first flowchart showing an example of a method of cleaning a liquid ejection head.

FIG. 4 is a second flowchart showing an example of the method of cleaning the liquid ejection head.

FIG. 5 is a diagram showing details of a first step.

FIG. 6 is a diagram showing an example of a first drive signal.

FIG. 7 is a diagram showing a waveform representing a vibration generated in a pressure chamber when driven by the first drive signal.

FIG. 8 shows the behavior of a first piezoelectric element driven by the first drive signal.

FIG. 9 is a diagram showing details of a second step.

FIG. 10 is a diagram showing an example of a second drive signal.

FIG. 11 is a diagram showing a waveform representing a vibration generated in the pressure chamber when driven by the second drive signal.

FIG. 12 shows the behavior of the first piezoelectric element driven by the second drive signal.

FIG. 13 is a diagram showing details of a third step.

FIG. 14 is a first diagram illustrating details of a fourth step.

FIG. 15 is a second diagram illustrating details of the fourth step.

FIG. 16 is a diagram showing an example of a third drive signal.

FIG. 17 is a diagram showing details of a fifth step.

FIG. 18 is a first diagram illustrating a method of cleaning the liquid ejection head in a second embodiment.

FIG. 19 is a second diagram illustrating the method of cleaning the liquid ejection head in the second embodiment.

FIG. 20 is a diagram showing an example of a fourth drive signal.

FIG. 21 is a diagram showing another example of the fourth drive signal.

### DESCRIPTION OF EMBODIMENTS

### A. First Embodiment

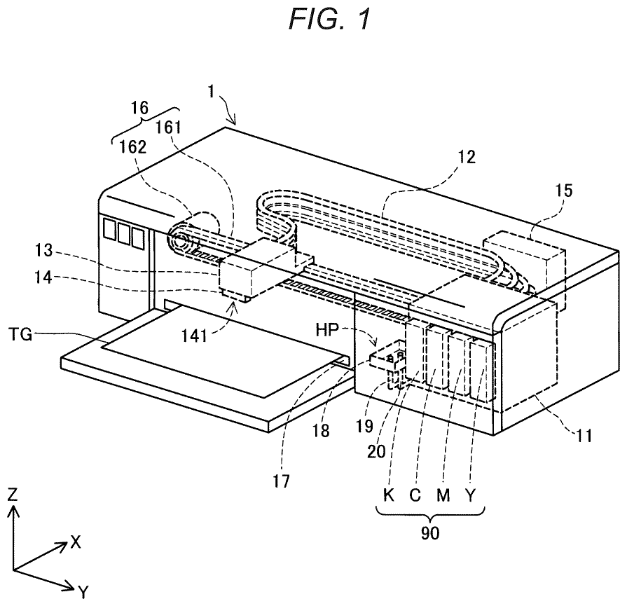

FIG. 1 is a diagram showing a schematic configuration of a liquid ejection apparatus 1. In FIG. 1, X-Y-Z axes, which are three spatial axes orthogonal to each other, are drawn. Directions to which the arrows of the X axis, the Y axis, and the Z axis point represent positive directions along the X axis, the Y axis, and the Z axis, respectively. The positive directions along the X axis, the Y axis, and the Z axis are defined as a +X direction, a +Y direction, and a +Z direction, respectively. Directions opposite to the directions to which the arrows of the X axis, the Y axis, and the Z axis point represent negative directions along the X axis, the Y axis, and the Z axis, respectively. The negative directions along the X axis, the Y axis, and the Z axis are defined as a −X direction, a −Y direction, and a −Z direction, respectively. The directions along the X axis, the Y axis, and the Z axis, in which the polarity does not matter, are defined as an X direction, a Y direction, and a Z direction, respectively.

In the present embodiment, in the use state of the liquid ejection apparatus 1, the X axis and the Y axis are axes along a horizontal plane, and the Z axis is an axis along the gravitational direction. Hereinafter, the gravitational direction is set to the −Z direction, and the anti-gravitational direction is set to the +Z direction. A direction from a rear surface side to a front surface side of the liquid ejection apparatus 1 is set to the −X direction, and a direction from the front surface side to the rear surface side is set to the +X direction. Further, when the liquid ejection apparatus 1 is viewed from the front surface side, a direction from the right side to the left side is set to the −Y direction, and a direction from the left side to the right side is set to the +Y direction. Note that the “use state of the liquid ejection apparatus 1” refers to a state in which the liquid ejection apparatus 1 is installed on a horizontal plane. The same applies to the drawings and the descriptions shown below.

In the present embodiment, the liquid ejection apparatus 1 is an inkjet printer that ejects ink as a liquid from a liquid ejection head 14. The liquid ejection apparatus 1 includes a cartridge mounting portion 11, a liquid circulation tube 12, a carriage 13, the liquid ejection head 14, a controller 15, a drive mechanism 16, a conveyance mechanism 17, a cap 18, a suction pump 19, and an on-off valve 20.

One or more cartridges 90 are detachably attached to the cartridge mounting portion 11. In the example shown in FIG. 1, four types of cartridges 90 are mounted on the cartridge mounting portion 11 so as to correspond to four colors of ink, yellow Y ink, magenta M ink, cyan C ink, and black K ink. Note that the types and the number of cartridges 90 mounted on the cartridge mounting portion 11 are not limited thereto. The liquid circulation tube 12 for circulating the ink is coupled to the cartridge mounting portion 11.

The carriage 13 is provided with the liquid ejection head 14. The carriage 13 moves the liquid ejection head 14 relative to an ejection target TG such as printing paper.

The liquid circulation tube 12 is coupled to the liquid ejection head 14. The ink is supplied to the liquid ejection head 14 from the cartridge 90 mounted on the cartridge mounting portion 11 via the liquid circulation tube 12. The liquid ejection head 14 is provided with a plurality of nozzles 141 that eject the ink for each of the types of the ink. The liquid ejection head 14 ejects the ink from the nozzles 141 toward the ejection target TG such as the printing paper. Accordingly, the liquid ejection head 14 prints data such as characters and images. In the present embodiment, the liquid ejection apparatus 1 is a so-called “off-carriage type” printer in which the cartridge mounting portion 11 does not move in conjunction with the movement of the carriage 13. In contrast, the technology of the present disclosure can also be applied to a so-called “on-carriage type” printer in which the cartridge mounting portion 11 is provided to the carriage 13 and the cartridge mounting portion 11 moves together with the carriage 13.

The controller 15 controls drive of the liquid ejection apparatus 1. Details of the controller 15 will be described later.

The drive mechanism 16 reciprocates the carriage 13 based on a drive signal received from the controller 15. The drive mechanism 16 includes a timing belt 161 and a drive motor 162. The drive mechanism 16 reciprocates the carriage 13 in a main scanning direction by transmitting the power of the drive motor 162 to the carriage 13 via the timing belt 161. In the present embodiment, the main scanning direction is a direction along the Y direction. The conveyance mechanism 17 moves the ejection target TG in a sub-scanning direction crossing the t main scanning direction based on the drive signal received from the controller 15. In the present embodiment, the sub-scanning direction is a direction along the X direction.

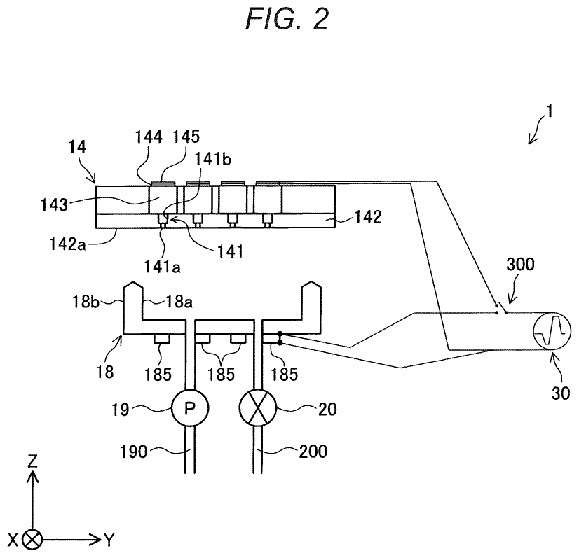

FIG. 2 is a diagram illustrating a detailed configuration of the liquid ejection apparatus 1. In FIG. 2, the liquid ejection head 14 and a peripheral configuration of the cap 18 are selectively illustrated from the liquid ejection apparatus 1. The liquid ejection head 14 includes a nozzle plate 142 provided with the plurality of nozzles 141, pressure chambers 143 respectively communicating with the nozzles 141, diaphragms 144 each constituting a part of the pressure chamber 143, and first piezoelectric elements 145 respectively stacked on the diaphragms 144. Further, the liquid ejection head 14 includes a reservoir (not illustrated) which is coupled to the liquid circulation tube 12 and is provided in common to the plurality of nozzles 141, and individual flow paths (not illustrated) which respectively couple the reservoir and the pressure chambers 143. The ink supplied to the liquid ejection head 14 via the liquid circulation tube 12 is temporarily stored in the reservoir and is supplied to the pressure chambers 143 via the individual flow paths. Then, when the first piezoelectric element 145 is driven based on a first drive signal received from the controller 15, the first piezoelectric element 145 is deformed and vibrated so as to bend in the −Z direction toward the pressure chamber 143. The vibration propagates to the diaphragm 144, the pressure in the pressure chamber 143 varies, and the volume of the pressure chamber 143 changes. Accordingly, the ink contained in the pressure chamber 143 is ejected from a nozzle opening 141a formed on a ejection surface 142a of the nozzle plate 142 through the nozzle 141.

The cap 18 can contain the liquid. The “liquid” mentioned here may be the liquid ejectionted from the liquid ejection head 14, that is, the ink, or may be a liquid other than the liquid ejectionted from the liquid ejection head 14, for example, a cleaning liquid. The cap 18 is disposed to face the ejection surface 142a of the nozzle plate 142 when cleaning the liquid ejection head 14, and can cover the ejection surface 142a of the nozzle plate 142. The “cleaning of the liquid ejection head 14” mentioned here refers to an operation of cleaning the periphery of the nozzle 141 to remove foreign matter from the liquid ejection head 14. The “foreign matter” is an object adhering to the ejection surface 142a of the nozzle plate 142 or a nozzle inner wall 141b, and is, for example, solidified ink or a fibrous object other than the ink. In the present embodiment, the cap 18 is disposed at a home position HP. As illustrated in FIG. 1, the home position HP is located in a region where the ejection target TG is not disposed in the liquid ejection apparatus 1, that is, a non-printing region.

As shown in FIG. 2, the cap 18 is provided with a second piezoelectric element 185. The second piezoelectric element 185 is driven based on a third drive signal received from the controller 15 to transmit ultrasonic waves to the liquid contained in the cap 18. The second piezoelectric element 185 is provided to the cap 18 for example, by bonding with an adhesive. In the present embodiment, the second piezoelectric element 185 is disposed at a position corresponding to the nozzle opening 141a of each of the nozzles 141 on an outer surface 18b of the cap 18 at an opposite side to the inner surface 18a facing the ejection surface 142a of the nozzle plate 142 when cleaning the liquid ejection head 14.

Note that in the present embodiment, the controller 15 switches a switch 300 of a signal generation circuit 30 that generates the first drive signal and the second drive signal for driving the first piezoelectric element 145 and the third drive signal for driving the second piezoelectric element 185. Accordingly, the piezoelectric elements 145, 185 as s control targets are switched, and each of the piezoelectric elements 145, 185 is driven in accordance with the drive signal. Details of each of the drive signals will be described later.

The suction pump 19 is disposed on a suction flow path 190 communicating with an inside of the cap 18. The suction pump 19 is driven based on a drive signal received from the controller 15 to thereby suck the liquid in the cap 18.

The on-off valve 20 is disposed on an air flow path 200 communicating with the inside of the cap 18. The on-off valve 20 is driven based on a drive signal received from the controller 15 to thereby switch between inflow of air into the cap 18 and discharge of air out of the cap 18.

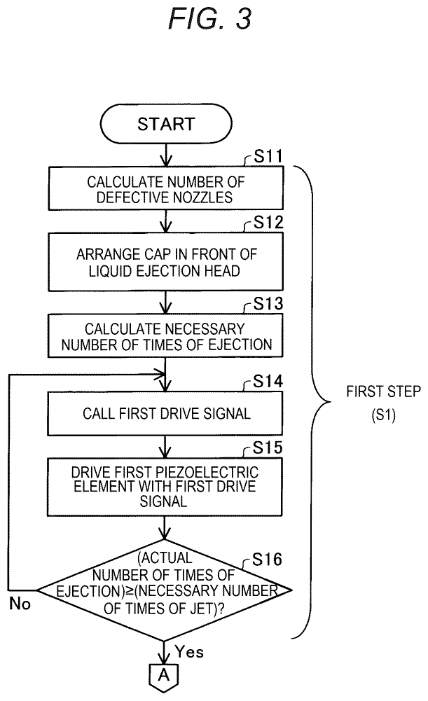

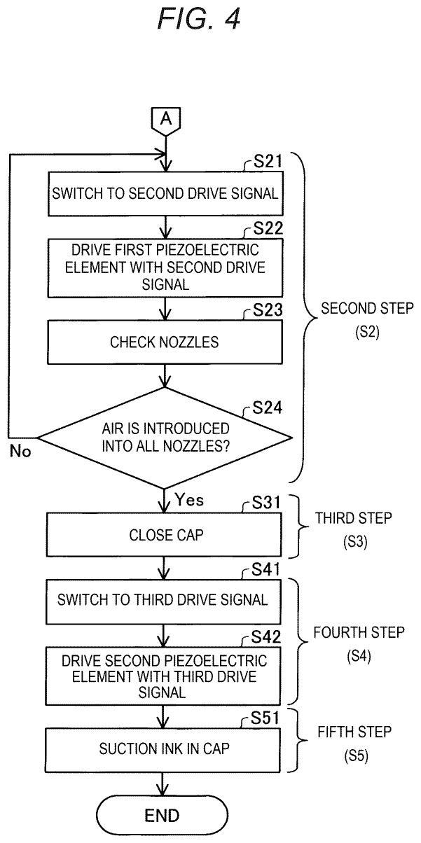

FIG. 3 is a first flowchart illustrating an example of a method of cleaning the liquid ejection head 14. FIG. 4 is a second flowchart illustrating an example of the method of cleaning the liquid ejection head 14. The flows illustrated in FIGS. 3 and 4 are executed when, for example, the nozzle 141 requires cleaning. The expression “when cleaning is required” used here is, for example, when time equal to or longer than time set in advance has elapsed from the previous cleaning operation. The expression “when cleaning is required” may also refer to a case where a request for a cleaning operation is received from the user. In the present embodiment, a case where the natural vibration period Tc of the pressure chamber 143 is 6.5 μs will be described as an example.

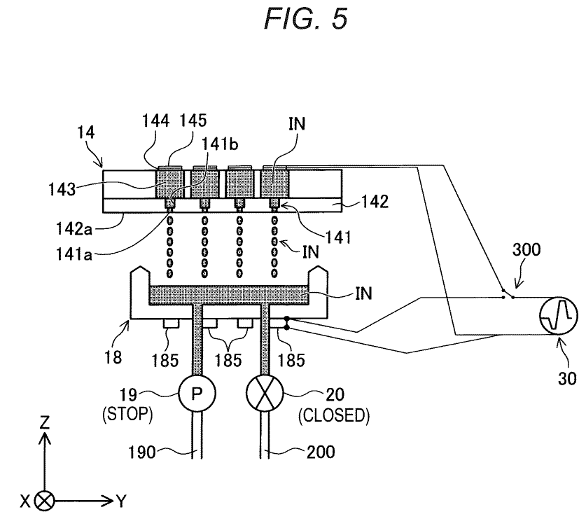

As shown in FIG. 3, first, a first step of step S1 is executed. FIG. 5 is a diagram showing details of the first step. The first step is a step of executing first processing of filling the inside of the cap 18 with the ink IN.

As shown in FIG. 3, in the first step, first, step S11 is executed. In step S11, the controller 15 calculates the number of defective nozzles. The defective nozzle is the nozzle 141 that cannot appropriately eject the ink IN due to adhesion of foreign matter or the like. The controller 15 calculates the number of defective nozzles by specifying whether foreign matter adheres to each of the nozzles 141 using, for example, a residual vibration when vibrating the first piezoelectric element 145. The controller 15 may calculate the number of defective nozzles by recognizing a pattern formed on the ejection target TG when the ink IN is ejected from all the nozzles 141 to specify whether foreign matter adheres to each of the nozzles 141. That is, the controller 15 may calculate the number of defective nozzles by printing a nozzle check pattern and specifying the presence or absence of adhesion of foreign matter to each of the nozzles 141 in accordance with the dot omission in the nozzle check pattern thus printed. In addition, the controller 15 may calculate the number of defective nozzles by analyzing a captured image obtained by imaging the ejection surface 142a of the nozzle plate 142 to specify the presence or absence of adhesion of foreign matter to each of the nozzles 141.

After step S11, step S12 is executed. In step S12, as illustrated in FIG. 5, the controller 15 disposes the cap 18 in front of the liquid ejection head 14. That is, the controller 15 moves at least one of the cap 18 and the liquid ejection head 14 such that the cap 18 and the ejection surface 142a of the nozzle plate 142 face each other. As shown in FIG. 1, in the present embodiment, the cap 18 is disposed at the home position HP. Therefore, the controller 15 drives the drive mechanism 16 to move the carriage 13 along the main scanning direction to move the liquid ejection head 14 to the home position HP, to thereby move the cap 18 to the front of the liquid ejection head 14.

As shown in FIG. 3, step S13 is executed after step S12. In step S13, the controller 15 calculates the necessary number of times of ejection. The necessary number of times of ejection is the number of times of ejection of the ink IN required to fill the inside of the cap 18 with the ink IN when all the first piezoelectric elements 145 corresponding to the nozzles 141 belonging to the nozzle group as the cleaning target are driven to eject the ink IN from all effective nozzles. The effective nozzle is the nozzle 141 capable of appropriately ejecting the ink IN. The expression “something is capable of appropriately ejecting the ink IN” means that the ink IN having a volume set in advance can be ejected. The controller 15 calculates the necessary number of times of ejection using the following formula (1).

NI=TW/(UW×GN) Formula (1)

In the above formula (1), NI is the necessary number of times of ejection. TW is a target ejection volume. The target ejection volume is a total volume of the ink IN required to fill the inside of the cap 18 with the ink IN. The reference symbol UW denotes a unit ejection volume. The unit ejection volume is a volume of the ink IN ejected from one nozzle 141 in each ejection operation. The reference symbol GN denotes the number of effective nozzles.

The controller 15 calculates the number of effective nozzles using the following formula (2).

GN=AN−DN Formula (2)

In the above formula (2), GN denotes the number of effective nozzles. The reference symbol AN denotes the total number of nozzles 141 belonging to the nozzle group as the cleaning target. The reference symbol DN denotes the number of defective nozzles calculated in step S11.

After step S13, step S14 is executed. In step S14, as illustrated in FIG. 5, the controller 15 switches the switch 300 to call the first drive signal generated by the signal generation circuit 30.

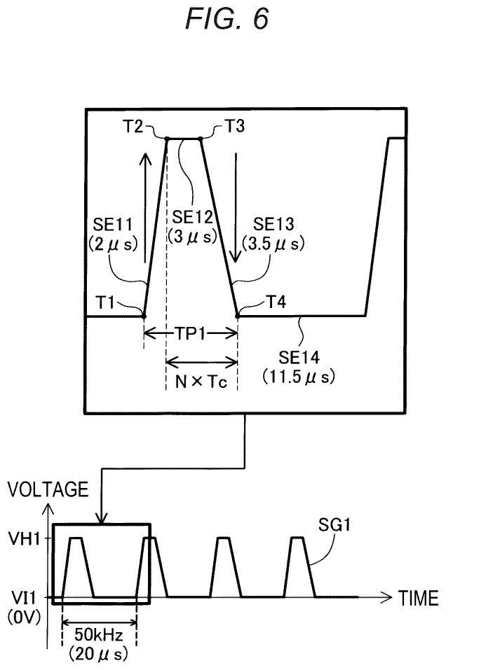

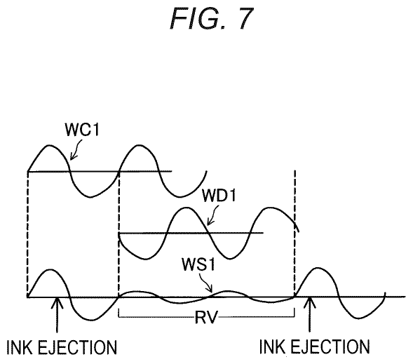

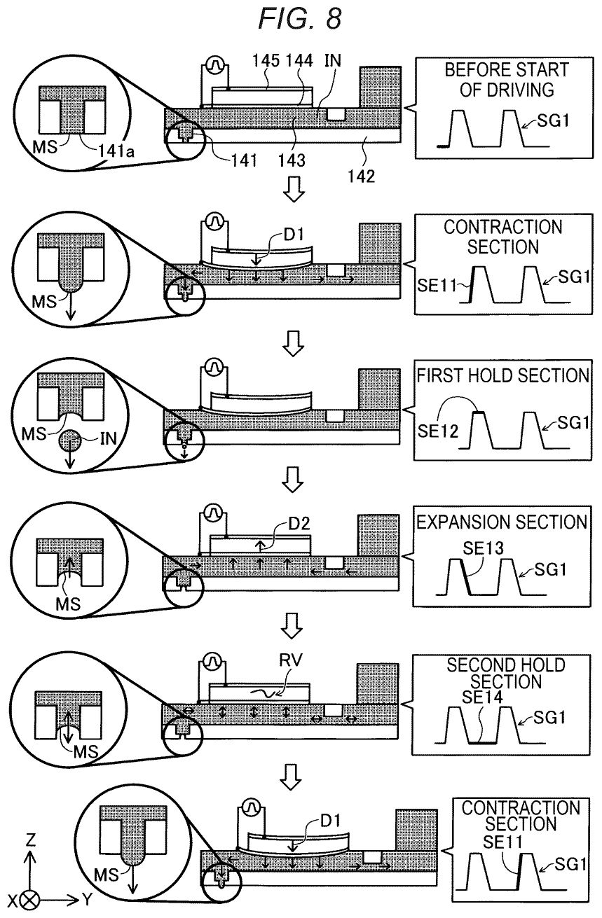

FIG. 6 is a diagram illustrating an example of the first drive signal SG1. FIG. 7 is a diagram illustrating waveforms WC1, WD1, and WS1 representing the vibrations generated in the pressure chamber 143 when the first piezoelectric element 145 is driven by the first drive signal SG1. FIG. 8 is a diagram illustrating the behavior when the first piezoelectric element 145 is driven by the first drive signal SG1. The first drive signal SG1 is a signal for changing the volume of the pressure chamber 143 by driving the first piezoelectric element 145 to deform the diaphragm 144. As illustrated in FIG. 6, in the present embodiment, the first drive signal SG1 is a consecutive pulse signal including a plurality of pulses each having a contraction section SE11, a first hold section SE12, an expansion section SE13, and a second hold section SE14. The frequency of the first drive signal SG1 is 50 KHz. The required time in one cycle of each of the pulses contained in the first drive signal SG1 is 20 μs.

As shown in FIG. 3, step S15 is executed after step S14. In step S15, as illustrated in FIG. 5, the controller 15 stops the suction pump 19, drives the first piezoelectric element 145 with the first drive signal SG1 in a state where the on-off valve 20 is closed, and ejects the ink IN from the nozzle 141. Note that as illustrated in FIG. 8, the first piezoelectric element 145 is at rest without being deformed at a time point before driving with the first drive signal SG1 is started. Accordingly, at the time point before the driving with the first drive signal SG1 is started, the pressure chamber 143 does not contract or expand, and is in a steady state in which the volume of the pressure chamber 143 is the reference volume. In the steady state, a meniscus MS which is an interface of the ink IN is maintained at a position of the nozzle opening 141a.

As illustrated in FIG. 8, in the contraction section SE11 of the first drive signal SG1, the controller 15 changes the voltage applied to the first piezoelectric element 145 to deform the first piezoelectric element 145 toward the −Z direction. In the present embodiment, as illustrated in FIG. 6, the controller 15 drives the first piezoelectric element 145 while increasing the voltage applied to the first piezoelectric element 145 from 0 V, which is the first initial voltage VI1, up to the first high voltage VH1, which is higher than the first initial voltage VI1, over 2 μs. As a result, the controller 15 deforms the first piezoelectric element 145 toward the −Z direction. When the first piezoelectric element 145 is deformed, as illustrated in FIG. 8, the first piezoelectric element 145 and the diaphragm 144 are deformed in the first direction D1 in which the volume of the pressure chamber 143 decreases, and the pressure chamber 143 becomes in a contracted state. In this way, by the pressure chamber 143 contracting, that is, the volume of the pressure chamber 143 decreasing, the meniscus MS protrudes from the nozzle opening 141a. Note that in the contraction section SE11 of the first drive signal SG1, such a vibration as indicated by the first contraction waveform WC1 in FIG. 7 is generated in the pressure chamber 143 due to the deformation of the diaphragm 144 due to the deformation of the first piezoelectric element 145.

As illustrated in FIG. 8, in the first hold section SE12 of the first drive signal SG1, the controller 15 maintains the bent state of the first piezoelectric element 145, that is, the deformation state of the first piezoelectric element 145 by keeping the voltage applied to the first piezoelectric element 145 constant without a change. In the present embodiment, as illustrated in FIG. 6, the controller 15 keeps the voltage applied to the first piezoelectric element 145 at the first high voltage VH1 for 3 μs to thereby maintain the deformation state of the first piezoelectric element 145. Accordingly, as illustrated in FIG. 8, the contracted state of the pressure chamber 143 is maintained, and the ink IN is ejected from the nozzle 141 so as to be pushed out from the pressure chamber 143.

As illustrated in FIG. 8, in the expansion section SE13 of the first drive signal SG1, the controller 15 changes the voltage applied to the first piezoelectric element 145 to deform the first piezoelectric element 145 such that the first piezoelectric element 145 is bent toward the +Z direction which is the opposite direction to the pressure chamber 143. In the present embodiment, as illustrated in FIG. 6, the controller 15 deforms the first piezoelectric element 145 toward the +Z direction by driving the first piezoelectric element 145 while lowering the voltage applied to the first piezoelectric element 145 from the first high voltage VH1 down to the first initial voltage VI1 over 3.5 μs. Accordingly, as illustrated in FIG. 8, the first piezoelectric element 145 and the diaphragm 144 are deformed in the second direction D2 returning to the steady state. In this way, the pressure chamber 143 expands from the contracted state to the steady state, that is, the volume of the pressure chamber 143 increases, so that the meniscus MS is drawn into the nozzle 141 from the nozzle opening 141a. Note that in the expansion section SE13 of the first drive signal SG1, such a vibration as indicated by the first expansion waveform WD1 in FIG. 7 is generated in the pressure chamber 143 due to the deformation of the diaphragm 144 due to the deformation of the first piezoelectric element 145.

As illustrated in FIG. 8, in the second hold section SE14 of the first drive signal SG1, the controller 15 maintains the deformation state of the first piezoelectric element 145 by keeping the voltage applied to the first piezoelectric element 145 constant without a change. In the present embodiment, as illustrated in FIG. 6, the controller 15 keeps the voltage applied to the first piezoelectric element 145 at the first initial voltage VI1 for 11.5 μs to thereby maintain the deformation state of the first piezoelectric element 145.

On this occasion, the vibration generated by driving the first piezoelectric element 145 in the contraction section SE11 and the vibration generated by driving the first piezoelectric element 145 in the expansion section SE13 propagate to the pressure chamber 143. Therefore, in the second hold section SE14 of the first drive signal SG1, the pressure chamber 143 vibrates with an amplitude obtained by combining the vibration generated in the contraction section SE11 of the first drive signal SG1 and the vibration generated in the expansion section SE13 of the first drive signal SG1. Accordingly, as illustrated in FIG. 7, in the second hold section SE14 of the first drive signal SG1, a residual vibration RV as illustrated in a first composite waveform WS1 obtained by combining the first contraction waveform WC1 and the first expansion waveform WD1 is generated in the pressure chamber 143.

Here, in the present embodiment, as illustrated in FIG. 6, the controller 15 drives the first piezoelectric element 145 using the first drive signal SG1 generated such that the required time from a start time point T2 of the first hold section SE12 to an end time point T4 of the expansion section SE13 matches the natural vibration period Tc of the pressure chamber 143. That is, in the expansion section SE13 of the first drive signal SG1, the controller 15 generates a vibration at a timing corresponding to the natural vibration period Tc of the pressure chamber 143 with respect to the vibration generated in the contraction section SE11 of the first drive signal SG1. In this way, as illustrated in FIG. 7, in the expansion section SE13 of the first drive signal SG1, vibration having a phase opposite to that of the contraction section SE11 of the first drive signal SG1 can be generated in the pressure chamber 143. Accordingly, as illustrated in FIG. 8, in the second hold section SE14 of the first drive signal SG1, since the vibration generated when the pressure chamber 143 contracts is canceled out, and thus, the residual vibration RV of the pressure chamber 143 is suppressed, the meniscus MS can be stabilized. As described above, in the first step, when the pulse of the next cycle is applied to the first piezoelectric element 145 and the ink IN is ejected from the nozzle 141 for the next time, the ink IN is ejected from the nozzle 141 in a state where the influence of the residual vibration RV of the pressure chamber 143 on the ejection of the ink IN is reduced.

As shown in FIG. 3, step S16 is executed after step S15. When “No” is determined in step S16, that is, when the actual number of times of ejection, which is the number of times the ink IN is actually ejected from the nozzle 141, is smaller than the necessary number of times of ejection calculated in step S13, the controller 15 determines that the inside of the cap 18 is not filled with the ink IN. Then, the controller 15 executes steps S14 to S16 once again. When “Yes” is determined in step S16, that is, when the actual number of times of ejection is equal to or greater than the necessary number of times of ejection calculated in step S13, the controller 15 determines that the inside of the cap 18 is filled with the ink IN. Then, as illustrated in FIG. 4, the controller 15 starts a second step in step S2.

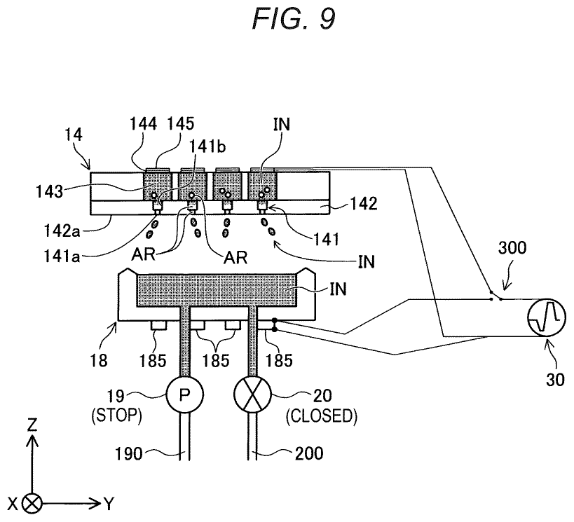

As shown in FIGS. 3 and 4, the second step is performed after the first step. FIG. 9 is a diagram illustrating details of the second step. The second step is a step of executing second processing of introducing the air AR into the nozzle 141.

As shown in FIG. 4, in the second step, first, step S21 is executed. In step S21, the controller 15 switches the drive signal used for control from the first drive signal SG1 to the second drive signal SG2.

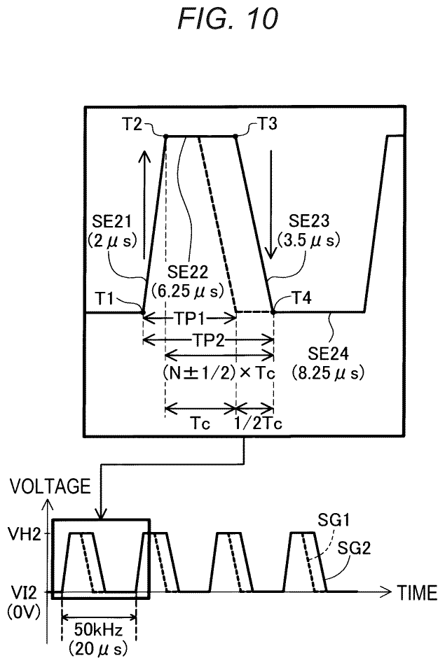

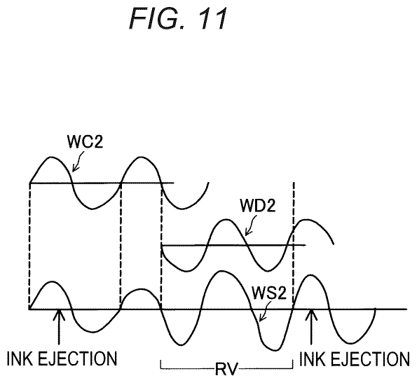

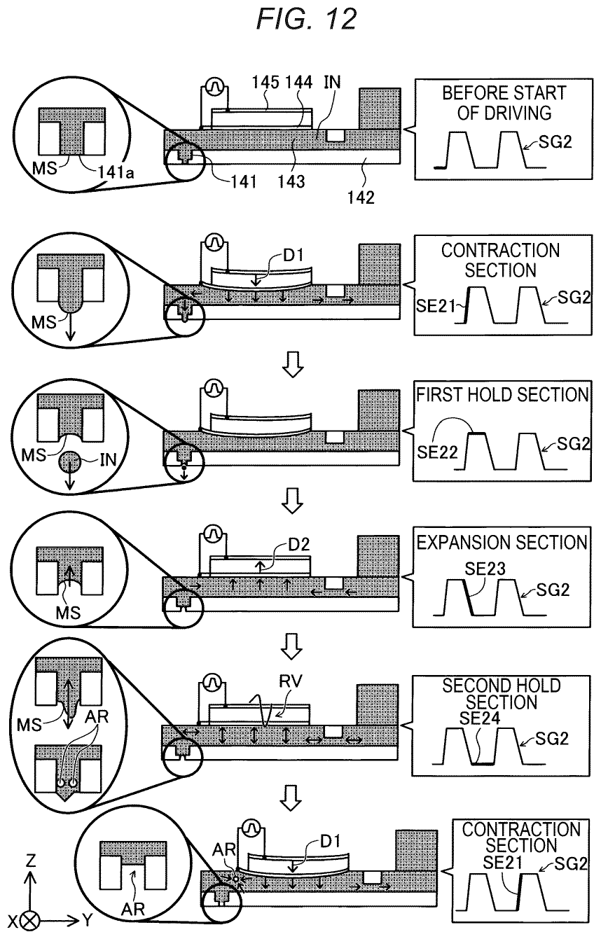

FIG. 10 is a diagram illustrating an example of the second drive signal SG2. In FIG. 10, the second drive signal SG2 is represented by a solid line, and the first drive signal SG1 illustrated in FIG. 6 is represented by a broken line. FIG. 11 is a diagram illustrating waveforms WC2, WD2, and WS2 representing the vibrations generated in the pressure chamber 143 when the first piezoelectric element 145 is driven by the second drive signal SG2. FIG. 12 is a diagram illustrating the behavior when the first piezoelectric element 145 is driven by the second drive signal SG2. The second drive signal SG2 is a signal for changing the volume of the pressure chamber 143 by driving the first piezoelectric element 145 to deform the diaphragm 144, and is a signal different from the first drive signal SG1. As illustrated in FIG. 10, in the present embodiment, the second drive signal SG2 is a consecutive pulse signal including a plurality of pulses each having a contraction section SE21, a first hold section SE22, an expansion section SE23, and a second hold section SE24. The frequency of the second drive signal SG2 is 50 kHz. The required time in one cycle of each of the pulses contained in the second drive signal SG2 is 20 μs.

As shown in FIG. 4, step S22 is executed after step S21. In step S22, the controller 15 stops the suction pump 19, drives the first piezoelectric element 145 with the second drive signal SG2 in a state where the on-off valve 20 is closed, and introduces the air AR into the nozzle 141. Note that as illustrated in FIG. 12, the state of the first piezoelectric element 145 is the steady state at a time point before driving with the second drive signal SG2 is started.

As illustrated in FIG. 12, in the contraction section SE21 of the second drive signal SG2, the controller 15 changes the voltage applied to the first piezoelectric element 145 to deform the first piezoelectric element 145 toward the −Z direction. In the present embodiment, as illustrated in FIG. 10, the controller 15 drives the first piezoelectric element 145 while increasing the voltage applied to the first piezoelectric element 145 from 0 V, which is the second initial voltage VI2, up to the second high voltage VH2, which is higher than the second initial voltage VI2, over 2 μs. As a result, the controller 15 deforms the first piezoelectric element 145 toward the −Z direction. That is, in the present embodiment, the control mode of the first piezoelectric element 145 in the contraction sections SE11, SE21 is the same between the first drive signal SG1 and the second drive signal SG2. When the first piezoelectric element 145 is deformed, as illustrated in FIG. 12, the first piezoelectric element 145 and the diaphragm 144 are deformed in the first direction D1 in which the volume of the pressure chamber 143 decreases, and the pressure chamber 143 becomes in the contracted state. In this way, by the pressure chamber 143 contracting, that is, the volume of the pressure chamber 143 decreasing, the meniscus MS protrudes from the nozzle opening 141a. Note that in the contraction section SE21 of the second drive signal SG2, vibration as represented by the second contraction waveform WC2 in FIG. 11 is generated in the pressure chamber 143 due to the deformation of the diaphragm 144 due to the deformation of the first piezoelectric element 145.

As illustrated in FIG. 12, in the first hold section SE22 of the second drive signal SG2, the controller 15 maintains the deformation of state the first piezoelectric element 145 by keeping the voltage applied to the first piezoelectric element 145 constant without change. In the present embodiment, as illustrated in FIG. 10, the controller 15 keeps the voltage applied to the first piezoelectric element 145 at the second high voltage VH2 for 6.25 μs to thereby maintain the deformation state of the first piezoelectric element 145. Accordingly, as illustrated in FIG. 12, the contracted state of the pressure chamber 143 is maintained, and the ink IN is ejected from the nozzle 141 so as to be pushed out from the pressure chamber 143.

As illustrated in FIG. 12, in the expansion section SE23 of the second drive signal SG2, the controller 15 changes the voltage applied to the first piezoelectric element 145 to deform the first piezoelectric element 145 toward the +Z direction. In the present embodiment, as illustrated in FIG. 10, the controller 15 deforms the first piezoelectric element 145 toward the +Z direction by driving the first piezoelectric element 145 while lowering the voltage applied to the first piezoelectric element 145 from the second high voltage VH2 down to the second initial voltage VI2 over 3.5 μs. That is, in the present embodiment, the control mode of the first piezoelectric element 145 in the expansion sections SE13, SE23 is the same between the first drive signal SG1 and the second drive signal SG2. Accordingly, as illustrated in FIG. 12, the first piezoelectric element 145 and the diaphragm 144 are deformed in the second direction D2 returning to the steady state. In this way, the pressure chamber 143 expands from the contracted state to the steady state, that is, the volume of the pressure chamber 143 increases, so that the meniscus MS is drawn into the nozzle 141 from the nozzle opening 141a. Note that in the expansion section SE23 of the second drive signal SG2, such a vibration as indicated by the second expansion waveform WD2 in FIG. 11 is generated in the pressure chamber 143 due to the deformation of the diaphragm 144 due to the deformation of the first piezoelectric element 145.

As illustrated in FIG. 12, in the second hold section SE24 of the second drive signal SG2, the controller 15 maintains the deformation state of the first piezoelectric element 145 by keeping the voltage applied to the first piezoelectric element 145 constant without a change. In the present embodiment, as illustrated in FIG. 10, the controller 15 keeps the voltage applied to the first piezoelectric element 145 at the second initial voltage VI2 for 8.25 μs to thereby maintain the deformation state of the first piezoelectric element 145.

On this occasion, the vibration generated by driving the first piezoelectric element 145 in the contraction section SE21 and the vibration generated by driving the first piezoelectric element 145 in the expansion section SE23 propagate to the pressure chamber 143. Therefore, in the second hold section SE24 of the second drive signal SG2, the pressure chamber 143 vibrates with an amplitude obtained by combining the vibration generated in the contraction section SE21 of the second drive signal SG2 and the vibration generated in the expansion section SE23 of the second drive signal SG2. Accordingly, as illustrated in FIG. 11, in the second hold section SE24 of the second drive signal SG2, a residual vibration RV as illustrated in a second composite waveform WS2 obtained by combining the second contraction waveform WC2 and the second expansion waveform WD2 is generated in the pressure chamber 143.

Here, in the present embodiment, as illustrated in FIG. 10, the controller 15 drives the first piezoelectric element 145 using the second drive signal SG2 generated so as to be different in target period TP1, TP2 from the first drive signal SG1. The target period TP is a period from a contraction start time point T1 of the pressure chamber 143 to an expansion end time point T4 of the pressure chamber 143. Specifically, the controller 15 sets the required time from a start time point T2 to an end time point T3 of the first hold section SE22 in the second drive signal SG2 to be longer than that in the first drive signal SG1 by 3.25 us that corresponds to a half of 6.5 μs as the natural vibration period Tc of the pressure chamber 143. That is, in the expansion section SE23 of the second drive signal SG2, the controller 15 generates a vibration at a timing corresponding to 3/2 of the natural vibration period Tc of the pressure chamber 143 with respect to the vibration generated in the contraction section SE21 of the second drive signal SG2. As described above, by shifting the target period TP by Tc/2 between the first drive signal SG1 and the second drive signal SG2, as illustrated in FIG. 11, it is possible to cause, in the expansion section SE23 of the second drive signal SG2, the pressure chamber 143 to vibrate in the same phase as the vibration in the contraction section SE21 of the second drive signal SG2. Accordingly, the vibration generated in the contraction section SE21 and the vibration generated in the expansion section SE23 resonate, and as illustrated in FIG. 12, the residual vibration RV of the pressure chamber 143 increases in the second hold section SE24 of the second drive signal SG2. Since the magnitude of the residual vibration RV of the pressure chamber 143 is proportional to the displacement amount of the meniscus MS, the meniscus MS is destabilized and vibrated by the increase in the residual vibration RV. By the vibration of the meniscus MS, the air AR existing around the nozzle opening 141a is drawn into the nozzle 141, and the air AR is introduced into the nozzle 141. In a state where the air AR is introduced into the nozzle 141, even when a pulse in the next cycle is applied to the first piezoelectric element 145 to contract the pressure chamber 143, the air AR in the nozzle 141 or the pressure chamber 143 is merely crushed, but the ink IN is not pushed out from the pressure chamber 143. Therefore, even when the pulse of the subsequent cycle is applied to the first piezoelectric element 145 to eject the ink IN again from the nozzle 141, the ink IN is not ejected, and the air AR introduced into the nozzle 141 is held in the nozzle 141 without being discharged to the outside of the nozzle 141. As described above, in the second step, by introducing the air AR into the nozzle 141 to replace at least a part of the ink IN in the nozzle 141 with the air AR, so-called “nozzle omission” in which the ink IN cannot be appropriately ejected from the nozzle 141 is induced. That is, in the second step, all the nozzles 141 belonging to the nozzle group as the cleaning target are intentionally changed to defective nozzles.

As shown in FIG. 4, step S23 is executed after step S22. In step S23, the controller 15 executes a nozzle check to confirm that the air AR has been introduced into all the nozzles 141 belonging to the nozzle group as the cleaning target. For example, the controller 15 calculates the number of defective nozzles by substantially the same method as in step S11, and determines that the air AR has been introduced into all the nozzles 141 as the cleaning target when the number of defective nozzles thus calculated matches the total number of nozzles 141 belonging to the nozzle group as the cleaning target.

After step S23, step S24 is executed. When “No” is determined in step S24, that is, when the air AR is not introduced into at least one of the nozzles 141 belonging to the nozzle group as the cleaning target, the controller 15 executes steps S21 to S24 once again. When “Yes” is determined in step S24, that is, when the air AR is introduced into all the nozzles 141 belonging to the nozzle group as the cleaning target, the controller 15 starts a third step in step S3.

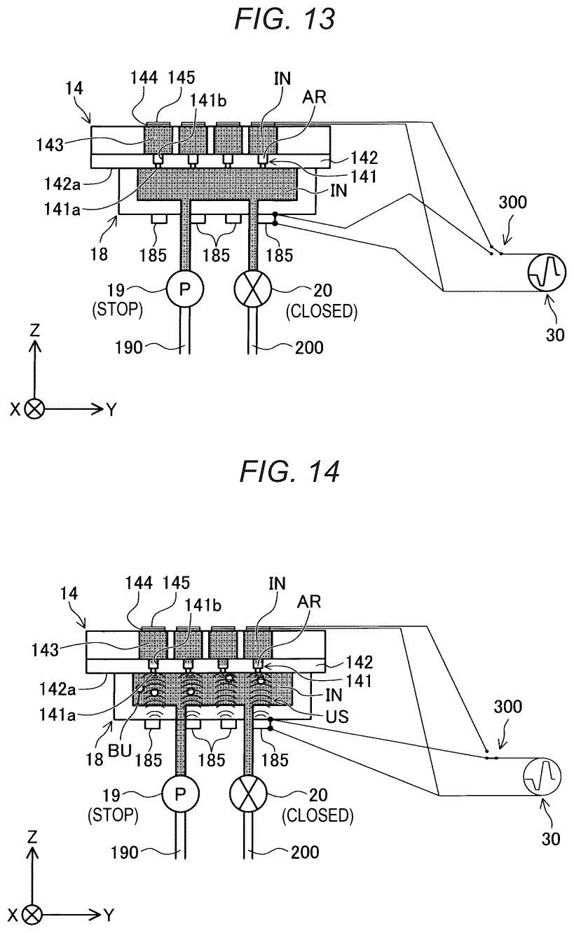

As shown in FIG. 4, the third step is executed after the second step. FIG. 13 is a diagram showing details of the third step. The third step is a step of performing third processing of bringing the ejection surface 142a of the nozzle plate 142 into contact with the ink IN in the cap 18 by closing the cap 18, that is, covering at least a part of the ejection surface 142a of the nozzle plate 142 with the cap 18. As shown in FIG. 4, in the third step, step S31 is executed. In step S31, as illustrated in FIG. 13, the controller 15 stops the suction pump 19 and moves at least one of the cap 18 and the liquid ejection head 14 in a state where the on-off valve 20 is closed. Accordingly, the ejection surface 142a of the nozzle plate 142 comes into contact with the ink IN in the cap 18 to form a sealed space. In the present embodiment, the controller 15 moves the cap 18 to come closer to the liquid ejection head 14. Accordingly, the nozzle openings 141a of all the nozzles 141 belonging to the nozzle group as the cleaning target are simultaneously brought into contact with the ink IN. In this way, it is possible to form a sealed space by sealing the nozzle opening 141a with the ink IN without letting out the air AR introduced into the nozzle 141.

Note that in a state where the ejection surface 142a of the nozzle plate 142 is in contact with the ink IN in the cap 18, negative pressure of about several kPa acting in a direction of sucking up the ink IN from the nozzle opening 141a into the nozzle 141 is generated in some cases in the liquid ejection head 14. However, in the state where the ejection surface 142a of the nozzle plate 142 is brought into contact with the ink IN in the cap 18 and the on-off valve 20 is closed, the inside of the liquid ejection head 14 is a sealed space, and there is no path for letting out the air AR. Therefore, even when the negative pressure acts in the direction of sucking up the ink IN from the nozzle opening 141a into the nozzle 141, gas-liquid exchange cannot be performed, and the amount of the ink IN sucked up into the cap 18 is very small. Therefore, the air AR introduced into the nozzle 141 in the second step is held in a space from the nozzle opening 141a to the pressure chamber 143 without being discharged from the nozzle opening 141a.

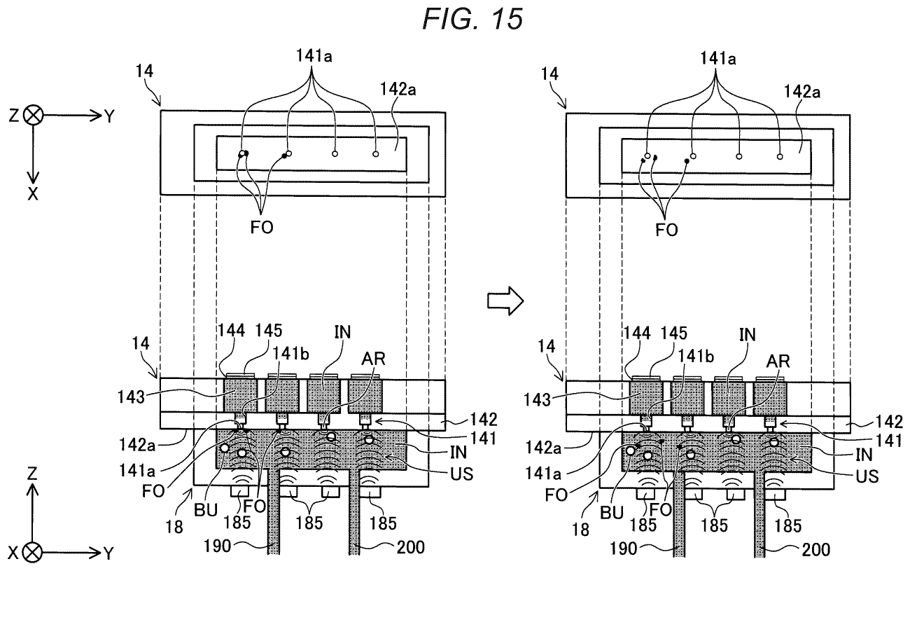

As shown in FIG. 4, a fourth step in step S4 is executed after the third step. FIG. 14 is a first diagram illustrating details of the fourth step. FIG. 15 is a second diagram illustrating details of the fourth step. The fourth step is a step of executing fourth processing of transmitting the ultrasonic wave US to the ink IN in the cap 18. As shown in FIG. 4, in the fourth step, first, step S41 is executed. In step S41, as illustrated in FIG. 14, the controller 15 switches the switch 300 to change the control target from the first piezoelectric element 145 to the second piezoelectric element 185, and switches the drive signal used for control from the second drive signal SG2 to the third drive signal SG3.

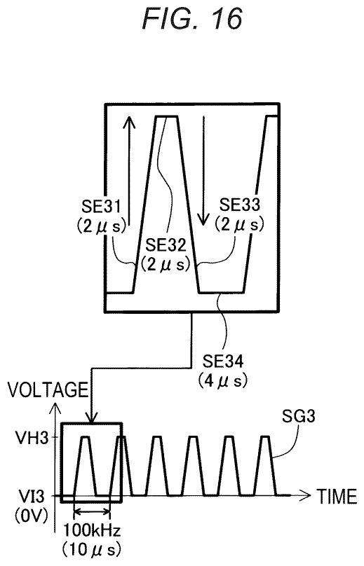

FIG. 16 is a diagram illustrating an example of the third drive signal SG3. The third drive signal SG3 is a signal for transmitting the ultrasonic wave US to the ink IN in the cap 18 by driving the second piezoelectric element 185 to ultrasonically vibrate the cap 18. In the present embodiment, the third drive signal SG3 is a consecutive pulse signal including a plurality of pulses each having a first deformation section SE31, a first hold section SE32, a second deformation section SE33, and a second hold section SE34. The frequency of the third drive signal SG3 is 100 kHz. The required time in one cycle of each of the pulses contained in the third drive signal SG3 is 10 μs. Note that the pulse shape, frequency, and period of the third drive signal SG3 are not limited to those described above. The frequency of the third drive signal SG3 sufficiently belongs to the frequency band in which the ultrasonic wave US can be transmitted, and may be, for example, no lower than 20 kHz or no higher than 10 MHz. That is, the frequency of the third drive signal SG3 is sufficiently no higher than the resonance frequency of the second piezoelectric element 185.

As shown in FIG. 4, step S42 is executed after step S41. In step S42, as illustrated in FIG. 14, the controller 15 stops the suction pump 19, and drives the second piezoelectric element 185 with the third drive signal SG3 in a state where the on-off valve 20 is closed to transmit the ultrasonic wave US to the ink IN in the cap 18.

As illustrated in FIG. 16, in the first deformation section SE31 of the third drive signal SG3, the controller 15 changes the voltage applied to the second piezoelectric element 185 to deform the second piezoelectric element 185 such that the second piezoelectric element 185 is bent in the +Z direction toward the cap 18. In the present embodiment, the controller 15 deforms the second piezoelectric element 185 toward the +Z direction by driving the second piezoelectric element 185 while increasing the voltage applied to the second piezoelectric element 185 from 0 V which is a third initial voltage VI3 to a third high voltage VH3 higher than the third initial voltage VI3 over 2 μs.

In the first hold section SE32 of the third drive signal SG3, the controller 15 maintains the deformation state of the second piezoelectric element 185 by keeping the voltage applied to the second piezoelectric element 185 constant without a change. In the present embodiment, the controller 15 maintains the deformation state of the second piezoelectric element 185 by keeping the voltage applied to the second piezoelectric element 185 at the third high voltage VH3 for 2 μs.

In the second deformation section SE33 of the third drive signal SG3, the controller 15 changes the voltage applied to the second piezoelectric element 185 to deform the second piezoelectric element 185 such that the second piezoelectric element 185 is bent in the −Z direction, which is the direction opposite to the cap 18. In the present embodiment, the controller 15 deforms the second piezoelectric element 185 toward the −Z direction by driving the second piezoelectric element 185 while lowering the voltage applied to the second piezoelectric element 185 from the third high voltage VH3 down to the third initial voltage VI3 over 2 μs.

In the second hold section SE34 of the third drive signal SG3, the controller 15 maintains the deformation state of the second piezoelectric element 185 by keeping the voltage applied to the second piezoelectric element 185 constant without a change. In the present embodiment, the controller 15 maintains the deformation state of the second piezoelectric element 185 by keeping the voltage applied to the second piezoelectric element 185 at the third initial voltage VI3 for 4 μs.

Here, in the present embodiment, the third drive signal SG3 is a consecutive pulse signal including a plurality of pulses for deforming the second piezoelectric element 185. Further, the frequency of the third drive signal SG3 belongs to a frequency band in which the ultrasonic wave US can be transmitted. Therefore, the second piezoelectric element 185 can be ultrasonically vibrated by driving the second piezoelectric element 185 with the third drive signal SG3. Further, the second piezoelectric element 185 is provided to the cap 18, and the ink IN is contained in the cap 18. Therefore, the ultrasonic vibration of the second piezoelectric element 185 propagates to the ink IN in the cap 18 via the cap 18. As described above, in the third step, the ultrasonic wave US is transmitted to the ink IN in the cap 18 by driving the second piezoelectric element 185 to ultrasonically vibrate the cap 18.

As illustrated in FIG. 15, by the ultrasonic wave US being transmitted to the ink IN in the cap 18 to ultrasonically vibrate the ink IN in the cap 18, cavitation can be generated in the ink IN in the cap 18. By causing the shock wave due to the collapse of air bubbles BU generated by the cavitation to collide with foreign matter FO, the foreign matter FO adhering to the nozzle 141 can be separated or floated.

On this occasion, the air AR is present in the nozzle 141. Since the acoustic impedance is greatly different between the air AR as a gas and the ink IN as a liquid, the ultrasonic wave US is reflected at the boundary between the air AR and the ink IN. Accordingly, the ultrasonic wave US emitted from the second piezoelectric element 185 propagates to the ink IN in the cap 18, but hardly propagates to the ink IN in the pressure chamber 143 through the nozzle 141. Therefore, it is possible to reduce the possibility that the impact pressure due to the cavitation propagates to the pressure chamber 143 through the ink IN to apply high pressure to the first piezoelectric element 145 and the diaphragm 144. As described above, in the fourth step, the foreign matter FO is separated or floated from the nozzle plate 142 in the state in which the possibility that the first piezoelectric element 145 and the diaphragm 144 are damaged is reduced.

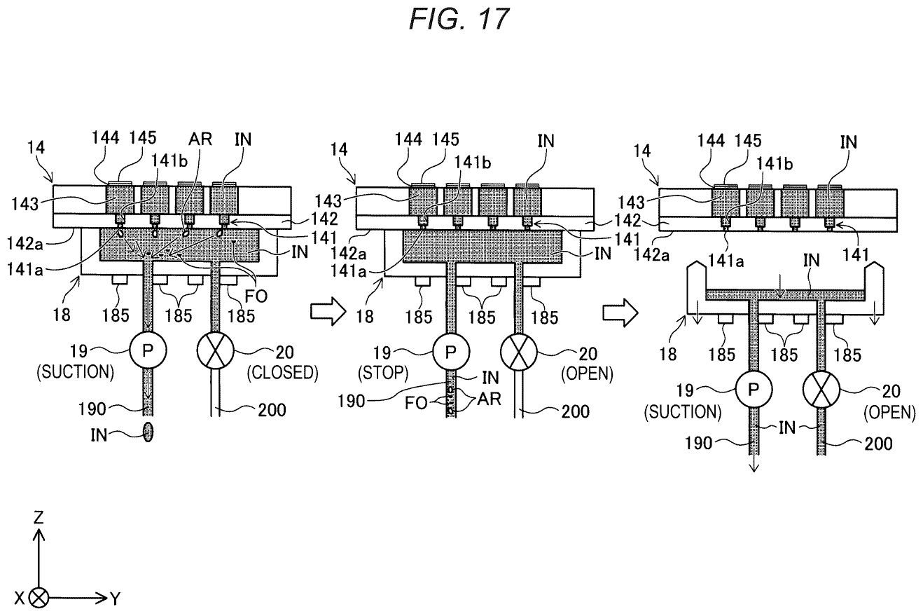

As shown in FIG. 4, a fifth step in step S5 is executed after the fourth step. FIG. 17 is a diagram illustrating details of the fifth step. The fifth step is a step of executing fifth processing of sucking the ink IN in the cap 18. As shown in FIG. 4, in the fifth step, step S51 is executed. In step S51, after stopping the drive of the second piezoelectric element 185, that is, after ending the transmission of the ultrasonic wave US, the controller 15 drives the suction pump 19 to suck the ink IN in the cap 18.

Specifically, first, as illustrated in the left diagram in FIG. 17, the controller 15 drives the suction pump 19 in a state where the on-off valve 20 is closed to suck the ink IN in the cap 18. Accordingly, the air AR introduced into the nozzle 141 is discharged to the outside of the nozzle 141, that is, to the inside of the cap 18, and the inside of the liquid ejection head 14 is filled with the ink IN. By filling the inside of the liquid ejection head 14 with the ink IN, the ink IN can be appropriately ejected from the nozzle 141 when the cleaning of the liquid ejection head 14 is completed and the printing operation is resumed. Then, as shown in the central diagram in FIG. 17, the controller 15 stops the suction pump 19 and then opens the on-off valve 20. Accordingly, the negative pressure generated in the cap 18 when the ink IN is sucked is released. The cap 18 can be detached by releasing the negative pressure in the cap 18. Then, as illustrated in the right diagram in FIG. 17, the controller 15 moves at least one of the cap 18 and the liquid ejection head 14 to remove the cap 18 from the liquid ejection head 14. In the present embodiment, the controller 15 moves the cap 18 to get away from the liquid ejection head 14. Then, the controller 15 drives the suction pump 19 again while keeping the on-off valve 20 open to suck the ink IN in the cap 18. Accordingly, the ink IN in the cap 18 is discharged to the outside of the cap 18. On this occasion, the foreign matter FO separated or floated from the nozzle plate 142 is also discharged to the outside of the cap 18 together with the ink IN. In this manner, the foreign matter FO is removed from the liquid ejection head 14. The ink IN discharged to the outside of the cap 18 is collected in, for example, a waste liquid tank (not shown).

After the ink IN in the cap 18 is discharged to the outside, the controller 15 may further wipe the ejection surface 142a of the nozzle plate 142 using a wiper (not illustrated). The term “wiping” mentioned here refers to an operation of moving a wiper while bringing the wiper into contact with the ejection surface 142a of the nozzle plate 142. In this way, the foreign matter FO separated or floated from the nozzle plate 142 can be more reliably removed from the liquid ejection head 14.

According to the first embodiment described above, the inside of the cap 18 can be filled with the liquid by driving the first piezoelectric element 145 with the first drive signal SG1 to eject the ink IN from the nozzle 141. Then, by bringing the ejection surface 142a of the nozzle plate 142 into contact with the ink IN in the cap 18 after the inside of the cap 18 is filled with the ink IN, a sealed space can be formed. Then, by driving the second piezoelectric element 185 with the third drive signal SG3 to transmit the ultrasonic wave US to the ink IN in the cap 18, the foreign matter FO can be separated or floated from the nozzle plate 142. Then, by sucking the ink IN in the cap 18 after the foreign matter FO is separated or floated from the nozzle plate 142, the foreign matter FO can be removed from the liquid ejection head 14. On this occasion, in the first embodiment described above, a part of the ink IN in the nozzle 141 is replaced with the air AR by driving the first piezoelectric element 145 with the second drive signal SG2 to introduce the air AR into the nozzle 141 before transmitting the ultrasonic wave US toward the nozzle plate 142. Therefore, when the ultrasonic wave US is transmitted toward the nozzle plate 142 to separate or float the foreign matter FO from the nozzle plate 142, the ink IN in the pressure chamber 143 and the ink IN in the cap 18 are separated by the air AR introduced into the nozzle 141. With such a configuration, it is possible to reduce the possibility that the impact pressure due to the cavitation propagates to the pressure chamber 143 through the ink IN to apply high pressure to the first piezoelectric element 145 and the diaphragm 144. Accordingly, when the foreign matter FO is separated or floated from the nozzle plate 142 using the ultrasonic wave US, it is possible to reduce the possibility that the first piezoelectric element 145 or the diaphragm 144 is damaged.

In particular, when the shape of the first piezoelectric element 145 is a thin film shape, for example, when the thickness of the first piezoelectric element 145 is 1.5 μm or less, the first piezoelectric element 145 is likely to be damaged when the foreign matter FO is separated or floated from the nozzle plate 142 using the ultrasonic wave US. Similarly, when the shape of the diaphragm 144 is a thin plate shape, for example, when the thickness of the diaphragm 144 is 2 μm or less, the diaphragm 144 is likely to be damaged when the foreign matter FO is separated or floated from the nozzle plate 142 using the ultrasonic wave US. In contrast, in the first embodiment described above, by introducing the air AR into the nozzle 141 before the foreign matter FO is separated or floated from the nozzle plate 142 using the ultrasonic wave US, the propagation of the impact pressure due to the cavitation to the pressure chamber 143 can be suppressed. With such a configuration, even when the liquid ejection head 14 includes the first piezoelectric element 145 shaped like a thin film or the diaphragm 144 shaped like a thin plate, the liquid ejection head 14 cleaned without damaging the first piezoelectric element 145 or the diaphragm 144.

In addition, according to the first embodiment, the air AR is introduced into the nozzle 141 by increasing the residual vibration RV in the pressure chamber 143, vibrating the meniscus MS, and drawing the air AR existing around the nozzle opening 141a into the nozzle 141. That is, only the air AR drawn by the vibration of the meniscus MS is present in the liquid ejection head 14, and the introduction amount of the air AR into the nozzle 141 is small compared to when the air AR is fed into the nozzle 141 from the outside of the liquid ejection head 14 by a pump or the like. With such a configuration, the amount of air AR discharged to the outside of the nozzle 141 when the cleaning of the liquid ejection head 14 is completed and the printing operation is resumed is smaller compared to when the air AR is fed into the nozzle 141 from the outside of the liquid ejection head 14 by a pump or the like. Therefore, the air AR introduced into the nozzle 141 can be discharged to the outside of the nozzle 141 using the suction pump 19 mounted in advance in the liquid ejection apparatus 1 without installing a dedicated device stronger in suction force than the suction pump 19 in the liquid ejection apparatus 1.

In addition, according to the first embodiment, the introduction amount of the air AR into the nozzle 141 is smaller compared to when the air AR is fed into the nozzle 141 from the outside of the liquid ejection head 14 by a pump or the like. Therefore, when the cleaning of the liquid ejection head 14 is completed and the printing operation is resumed, it is possible to suppress the consumption amount of the ink IN required to fill the liquid ejection head 14 with the ink IN.

Further, according to the first embodiment, the first drive signal SG1 and the second drive signal SG2 are each a signal for changing the volume of the pressure chamber 143 by driving the first piezoelectric element 145 to deform the diaphragm 144. When the first piezoelectric element 145 is driven with the first drive signal SG1, the vibration generated when the pressure chamber 143 contracts can be attenuated when the pressure chamber 143 expands. Further, the first piezoelectric element 145 is driven such expansion of the pressure chamber 143 are different between the first drive signal SG1 and the second drive signal SG2. With such a configuration, by driving the first piezoelectric element 145 with the second drive signal SG2, the vibration generated when the pressure chamber 143 contracts can be amplified when the pressure chamber 143 expands. Accordingly, the residual vibration RV in the pressure chamber 143 can be increased. By increasing the residual vibration RV, the meniscus MS is destabilized and vibrated, and the air AR existing around the nozzle opening 141a is drawn into the nozzle 141, and thus, the air AR can be introduced into the nozzle 141.

Note that in the first embodiment, as illustrated in FIG. 10, between the first drive signal SG1 and the second drive signal SG2, the required time in the contraction sections SE 11, SE21 and the required time in the expansion sections SE13, SE23 are the same, and the required time in the hold sections SE12, SE14, SE22, and SE24 is different. Accordingly, the target periods TP1, TP2 are different between the first drive signal SG1 and the second drive signal SG2. In contrast, the pulse shapes, frequencies, and periods of the first drive signal SG1 and the second drive signal SG2 are not limited to those described above. The target periods TP1, TP2 of the first drive signal SG1 and the second drive signal SG2 may be different 1 from each other by the required time being different at least one of between the contraction sections SE11, SE21 and between the expansion sections SE13, SE23. Even with such a configuration, by driving the first piezoelectric element 145 with the second drive signal SG2, the vibration generated when the pressure chamber 143 contracts can be amplified when the pressure chamber 143 expands. Accordingly, the residual vibration RV in the pressure chamber 143 can be increased. Due to the increase in the residual vibration RV, the meniscus MS is destabilized and vibrates. By drawing the air AR existing around the nozzle opening 141a into the nozzle 141 due to the vibration of the meniscus MS, the air AR can be introduced into the nozzle 141.

Further, according to the first embodiment described above, the first drive signal SG1 is a signal for changing the volume e of the pressure chamber 143 by generating, during the expansion of the pressure chamber 143, the vibration at the timing corresponding to N times (N is an integer), that is, an integer multiple of the natural vibration period Tc of the pressure chamber 143 with respect to the vibration generated when the pressure chamber 143 contracts. Therefore, by driving the first piezoelectric element 145 with the first drive signal SG1, it is possible to generate, when the pressure chamber 143 expands, the vibration having a phase opposite to that of the vibration generated when the pressure chamber 143 contracts. That is, by driving the first piezoelectric element 145 with the first drive signal SG1, the vibration generated when the pressure chamber 143 contracts can be canceled out when the pressure chamber 143 expands. Further, when the natural vibration period of the pressure chamber 143 is denoted by Tc, the target period TP2 of the second drive signal SG2 is shifted by Tc/2 from the target period TP1 of the first drive signal SG1. That is, the second drive signal SG2 is a signal for changing the volume of the pressure chamber 143 by generating, when the pressure chamber 143 expands, a vibration at a timing corresponding to N±1/2 times of the natural vibration period Tc of the pressure chamber 143 with respect to the vibration generated when the pressure chamber 143 contracts. With such a configuration, by driving the first piezoelectric element 145 with the second drive signal SG2, it is possible to generate, when the pressure chamber 143 expands, the vibration having the same phase as the vibration generated when the pressure chamber 143 contracts. That is, the vibration generated when the pressure chamber 143 contracts and the vibration generated when the pressure chamber 143 expands can be made to resonate. Therefore, by driving the first piezoelectric element 145 with the second drive signal SG2, the vibration generated when the pressure chamber 143 contracts can be further amplified when the pressure chamber 143 expands. Accordingly, the residual vibration RV of the pressure chamber 143 can be more reliably increased. Therefore, the air AR can be quickly introduced into the nozzle 141.

Further, in the first embodiment described above, in FIG. 6, a case where the multiple N with respect to the natural vibration period Tc of the pressure chamber 143 is 1 is exemplified. That is, the first drive signal SG1 shown in FIG. 6 is a signal for changing the volume of the pressure chamber 143 by generating, when the pressure chamber 143 expands, a vibration at a timing corresponding to the natural vibration period Tc of the pressure chamber 143 with respect to the vibration generated when the pressure chamber 143 contracts. With such a configuration, it is possible to prevent the first piezoelectric element 145 from vibrating more than necessary after ejecting the ink IN to increase the residual vibration RV of the pressure chamber 143. Note that the multiple N is sufficiently an integer no smaller than 1, and may be an integer no smaller than 2. For example, the multiple N may be 2, that is, the first drive signal SG1 may be a signal for changing the volume of the pressure chamber 143 by generating, when the pressure chamber 143 expands, a vibration at a timing corresponding to twice the natural vibration period Tc of the pressure chamber 143 with respect to the vibration generated when the pressure chamber 143 contracts. Even with such a configuration, by driving the first piezoelectric element 145 with the first drive signal SG1, the vibration generated when the pressure chamber 143 contracts can be canceled out when the pressure chamber 143 expands. Therefore, when the pulse of the next cycle is applied to the first piezoelectric element 145 and the ink IN is ejected from the nozzle 141 for the next time, the ink IN can be ejected from the nozzle 141 in the state where the influence of the residual vibration RV of the pressure chamber 143 on the ejection of the ink IN is reduced.

Further, in the first embodiment described above, in FIG. 10, a case where the multiple N with respect to the natural vibration period Tc of the pressure chamber 143 is 1 is exemplified. That is, the second drive signal SG2 illustrated in FIG. 10 is a signal for changing the volume of the pressure chamber 143 by generating, when the pressure chamber 143 expands, a vibration at a timing corresponding to 3/2 times of the natural vibration period Tc of the pressure chamber 143 with respect to the vibration generated when the pressure chamber 143 contracts. With such a configuration, the residual vibration RV of the pressure chamber 143 can more quickly be increased. Note that the multiple N is sufficiently an integer no smaller than 1, and may be an integer no smaller than 2. For example, the multiple N may be 2, that is, the second drive signal SG2 may be a signal for changing the volume of the pressure chamber 143 by generating, when the pressure chamber 143 expands, a vibration at a timing corresponding to 5/2 times of the natural vibration period Tc of the pressure chamber 143 with respect to the vibration generated when the pressure chamber 143 contracts. Even with such a configuration, by driving the first piezoelectric element 145 with the second drive signal SG2, the vibration generated when the pressure chamber 143 contracts can be amplified when the pressure chamber 143 expands. Therefore, the air AR can be quickly introduced into the nozzle 141.

Note that when the natural vibration period of the pressure chamber 143 is denoted by Tc, the target period TP2 of the second drive signal SG2 may be shifted from the target period TP1 of the first drive signal SG1 by 0.3 times or more of the natural vibration period Tc, or may be shifted by 0.7 times or less of the natural vibration period Tc. Even with such a configuration, by driving the first piezoelectric element 145 with the second drive signal SG2, the vibration generated when the pressure chamber 143 contracts can be amplified when the pressure chamber 143 expands. Therefore, the air AR can be quickly introduced into the nozzle 141.

Further, according to the first embodiment described above, the second piezoelectric element 185 is disposed on the outer surface 18b of the cap 18. With such a configuration, the second piezoelectric element 185 does not come into contact with the ink IN in the cap 18. Therefore, the second piezoelectric element 185 can be provided to the cap 18 without requiring a member or a work for protecting an electrode constituting the second piezoelectric element 185 from the ink IN. Further, with such a configuration, the second piezoelectric element 185 can be easily attached to the cap 18 using an adhesive or the like.

Further, according to the first embodiment described above, the second piezoelectric element 185 is in close contact with and bonded to the cap 18. With such a configuration, the ultrasonic wave US can be efficiently propagated from the second piezoelectric element 185 to the ink IN in the cap 18.

Further, according to the first embodiment described above, the second piezoelectric element 185 is disposed at a position corresponding to the nozzle opening 141a of each of the nozzles 141. In other words, the second piezoelectric element 185 is disposed in a direction in which the ultrasonic wave US can be transmitted toward the nozzle 141. With such a configuration, since the ultrasonic wave US can be locally transmitted toward the nozzle 141, the bubbles BU due to the cavitation can be generated so as to be concentrated in the vicinity of the nozzle opening 141a. Accordingly, since it is possible to increase the possibility that the shock wave generated by the collapse of the bubble BU generated by the cavitation collides with the foreign matter FO, it is possible to more reliably separate or float the foreign matter FO from the nozzle plate 142.

Further, according to the first embodiment described above, the liquid ejection apparatus 1 includes the signal generation circuit 30 that generates the first drive signal SG1, the second drive signal SG2, and the third drive signal SG3 and that can switch the control target between the piezoelectric elements 145, 185 with the switch 300. With such a configuration, each of the first piezoelectric element 145 and the second piezoelectric element 185 can be driven with the different drive signals SG1, SG2, and SG3 using the common circuit. Accordingly, since the circuit configuration for driving each of the piezoelectric elements 145, 185 can be simplified, it is possible to reduce the size of the liquid ejection apparatus 1 and to reduce the cost required for manufacturing the liquid ejection apparatus 1. Further, by using the common circuit, the liquid ejection head 14 can be cleaned without detaching the liquid ejection head 14 from the liquid ejection apparatus 1.

Further, according to the first embodiment described above, the inside of the cap 18 is filled with the ink IN by ejecting the ink IN from the nozzles 141, and the foreign matter FO can be separated or floated from the nozzle plate 142 by transmitting the ultrasonic wave US to the ink IN in the cap 18. With such a configuration, since the liquid ejection head 14 can be cleaned using the liquid used in the printing operation, the liquid ejection head 14 can be cleaned without detaching the liquid ejection head 14 from the liquid ejection apparatus 1.

Note that the cap 18 may be filled with a liquid other than the ink IN by injecting a liquid other than the ink IN such as a cleaning liquid into the cap 18 using a supply device (not illustrated). That is, the liquid ejection head 14 may be cleaned using a liquid other than the liquid used in the printing operation. When the liquid ejection head 14 is cleaned using a liquid other than the liquid used in the printing operation, the expression “ink” in the present disclosure can be appropriately replaced with “liquid.” With such a configuration, by filling the inside of the cap 18 with the liquid according to the composition of the liquid to be ejected from the liquid ejection head 14 and the composition and state of the foreign matter FO, it is possible to increase the cleaning power of the liquid ejection head 14 or improve the cleaning efficiency of the liquid ejection head 14.

Further, a main body of the cap 18 may be formed of a hard material such as resin that is hardly deformed by pressure. With such a configuration, it is possible to prevent the cap 18 from being deformed in a direction in which the cap 18 contracts in a state where the ejection surface 142a of the nozzle plate 142 is in contact with the liquid in the cap 18. Accordingly, since the ink IN in the cap 18 can be prevented from being pushed out of the cap 18, the ink IN can be retained in the cap 18. Therefore, it is possible to avoid a situation in which the ink IN in the cap 18 is sucked into the nozzle 141 from the nozzle opening 141a, and all the air AR introduced into the nozzle 141 moves to the pressure chamber 143 side, and thus, the air AR functioning as a buffer material does not exist in the nozzle 141 when the ultrasonic wave US is transmitted.

### B. Second Embodiment

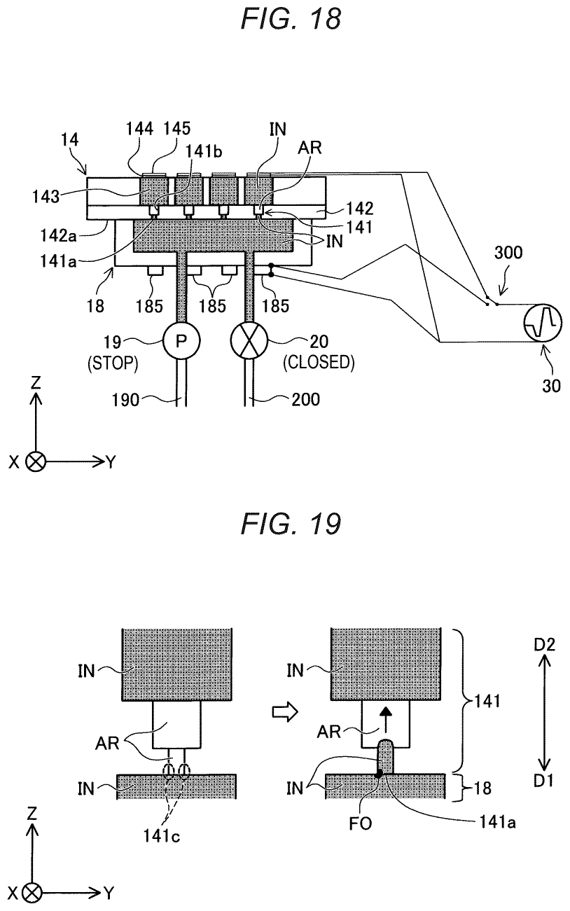

FIG. 18 is a first diagram illustrating a method of cleaning the liquid ejection head 14 in a second embodiment. FIG. 19 is a second diagram illustrating the method of cleaning the liquid ejection head 14 in the second embodiment. As illustrated in FIG. 19, foreign matter FO may adhere to an edge portion 141c where the ejection surface 142a of the nozzle plate 142 and the nozzle inner wall 141b intersect. On this occasion, the ultrasonic wave US is reflected at the boundary between the air AR and the ink IN and hardly propagates in the air AR. Therefore, when the edge portion 141c is not immersed in the ink IN, the foreign matter FO adhering to the edge portion 141c may not be sufficiently separated or floated using the ultrasonic wave US in some cases. Therefore, as illustrated in FIG. 18, the controller 15 stops the suction pump 19, and drives the first piezoelectric element 145 with a fourth drive signal in a state where the on-off valve 20 is closed to slightly draw the ink IN in the cap 18 into the nozzle 141 from the nozzle opening 141a. Accordingly, as illustrated in FIG. 19, the edge portion 141c is immersed in the ink IN. Subsequently, as illustrated in FIG. 14, the controller 15 drives the second piezoelectric element 185 with the third drive signal SG3 to transmit the ultrasonic wave US to the ink IN in the cap 18. That is, in the fourth step, the controller 15 drives the second piezoelectric element 185 in a state where the pressure chamber 143 is expanded.

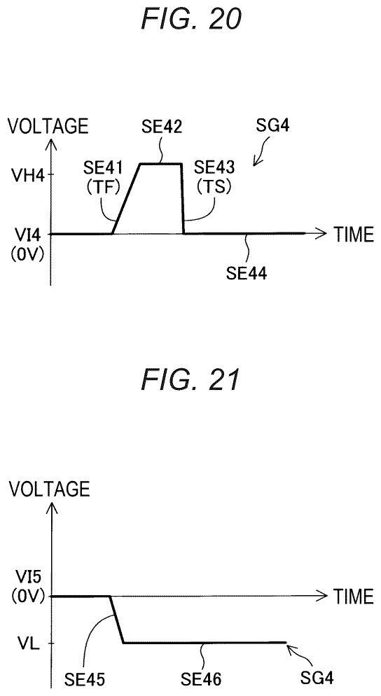

FIG. 20 is a diagram illustrating an example of the fourth drive signal SG4. The fourth drive signal SG4 is a signal for expanding the pressure chamber 143 by driving the first piezoelectric element 145 to deform the diaphragm 144. In the present embodiment, the fourth drive signal SG4 is a single pulse signal having at least a contraction section SE41, a first hold section SE42, an expansion section SE43, and a second hold section SE44.

In the contraction section SE41 of the fourth drive signal SG4, the controller 15 changes the voltage applied to the first piezoelectric element 145 to deform the first piezoelectric element 145 toward the −Z direction. In the present embodiment, the controller 15 deforms the first piezoelectric element 145 toward the −Z direction by driving the first piezoelectric element 145 while increasing the voltage applied to the first piezoelectric element 145 from 0 V which is a fourth initial voltage VI4 to a fourth high voltage VH4 higher than the fourth initial voltage VI4 over a first time TF. Accordingly, the first piezoelectric element 145 and the diaphragm 144 are deformed in the first direction D1 in which the volume of the pressure chamber 143 decreases, and the pressure chamber 143 becomes in the contracted state.

In the first hold section SE42 of the fourth drive signal SG4, the controller 15 maintains the deformation state of the first piezoelectric element 145 by keeping the voltage applied to the first piezoelectric element 145 constant without a change. In the present embodiment, the controller 15 maintains the deformation state of the first piezoelectric element 145 by keeping the voltage applied to the first piezoelectric element 145 at the fourth high voltage VH4. Accordingly, the contracted state of the pressure chamber 143 is maintained.

In the expansion section SE43 of the fourth drive signal SG4, the controller 15 changes the voltage applied to the first piezoelectric element 145 to deform the first piezoelectric element 145 toward the +Z direction. In the present embodiment, the controller 15 deforms the first piezoelectric element 145 toward the +Z direction by driving the first piezoelectric element 145 while lowering the voltage applied to the first piezoelectric element 145 from the fourth high voltage VH4 to the fourth initial voltage VI4 over a second time TS. Accordingly, the first piezoelectric element 145 and the diaphragm 144 are deformed in the second direction D2 of returning to the steady state, and the pressure chamber 143 expands from the contracted state to the steady state. As a result, as shown in FIG. 19, the ink IN in the cap 18 is slightly drawn into the nozzle 141 from the nozzle opening 141a.

As illustrated in FIG. 20, in the second hold section SE44 of the fourth drive signal SG4, the controller 15 maintains the deformation state of the first piezoelectric element 145 by keeping the voltage applied to the first piezoelectric element 145 constant without a change. In the present embodiment, the controller 15 maintains the deformation state of the first piezoelectric element 145 by keeping the voltage applied to the first piezoelectric element 145 at the fourth initial voltage VI4. Accordingly, the pressure chamber 143 is maintained in a state of being expanded more than the steady state, and the ink IN in the cap 18 is maintained in a state of being slightly drawn into the nozzle 141 from the nozzle opening 141a.

According to the second embodiment described above, in a state where the pressure chamber 143 is expanded, that is, in a state where a small amount of the ink IN is drawn into the nozzle 141 and the edge portion 141c is immersed in the ink IN, the second piezoelectric element 185 can be driven to transmit the ultrasonic wave US to the ink IN in the cap 18. With such a configuration, the foreign matter FO adhering to the edge portion 141c can be more reliably separated or floated.

Further, according to the second embodiment described above, the expanded state of the pressure chamber 143 can be maintained by driving the first piezoelectric element 145 with the fourth drive signal SG4 before transmitting the ultrasonic wave US to the ink IN in the cap 18. With such a configuration, when the foreign matter FO is separated or floated from the nozzle plate 142 using the ultrasonic wave US, the state in which a small amount of the ink IN is drawn into the nozzle 141 can be maintained. That is, in the fourth step, the state in which the edge portion 141c is immersed in the ink IN can be maintained.

Further, according to the second embodiment described above, in the fourth drive signal SG4, the second time TS, which is the time required for the expansion section SE43, is shorter than the first time TF, which is the time required for the contraction section SE41. That is, the pressure chamber 143 contracts slowly, and then expands quickly. With such a configuration, it is possible to generate negative pressure large in magnitude in the direction of sucking up the ink IN from the nozzle opening 141a toward the pressure chamber 143. Therefore, the ink IN in the cap 18 can be more reliably drawn from the nozzle opening 141a toward the pressure chamber 143.

Note that the pulse shape of the fourth drive signal SG4 is not limited to the above. FIG. 21 is a diagram illustrating another example of the fourth drive signal SG4. The fourth drive signal SG4 is sufficiently a pulse signal having at least an expansion section SE45 for expanding the pressure chamber 143 and a hold section SE46 for maintaining the pressure chamber 143 in the expanded state, and may be such a signal as illustrated in FIG. 21. In this case, in the expansion section SE45 of the fourth drive signal SG4, the controller 15 deforms the first piezoelectric element 145 toward the +Z direction by driving the first piezoelectric element 145 while lowering the voltage applied to the first piezoelectric element 145 from 0 V which is a fifth initial voltage VI5 to a low voltage VL lower than the fifth initial voltage VI5. Accordingly, the first piezoelectric element 145 and the diaphragm 144 are deformed in the second direction D2 of returning to the steady state, and the pressure chamber 143 expands from the contracted state to the steady state. Accordingly, the ink IN in the cap 18 is slightly drawn into the nozzle 141 from the nozzle opening 141a. Then, in the hold section SE46 of the fourth drive signal SG4, the controller 15 maintains the deformation state of the first piezoelectric element 145 by keeping the voltage applied to the first piezoelectric element 145 at the low voltage VL. Accordingly, the pressure chamber 143 is maintained in a state of being expanded more than the steady state, and the ink IN in the cap 18 is maintained in a state of being slightly drawn into the nozzle 141 from the nozzle opening 141a. Also with such a configuration, when the foreign matter FO is separated or floated from the nozzle plate 142 using the ultrasonic wave US, the state in which a small amount of the ink IN is drawn into the nozzle 141 can be maintained.

### C. Other Embodiments

### C-1. Another Embodiment 1

The liquid ejection apparatus 1 may be an apparatus other than the inkjet printer. When the liquid ejection apparatus 1 is an apparatus other than the inkjet printer, the expression “ink” in the present disclosure can be appropriately replaced with “liquid.”

### C-2. Another Embodiment 2

In each of the embodiments described above, at least some of the components realized by hardware may be realized by software, and conversely, at least some of the components realized by software may be realized by hardware.

### D. Other Aspects

The present disclosure is not limited to the embodiments described above and can be implemented in various configurations without departing from the gist of the present disclosure. For example, technical features in the embodiments corresponding to the technical features in the aspects described in the field of the summary of the disclosure can be replaced and combined as appropriate in order to solve some or all of the problems described above or in order to achieve some or all of the advantages described above. Further, any of the technical features can be eliminated as appropriate unless described as essential in the present specification.
(1) According to an aspect of the present disclosure, a method of cleaning a liquid ejection head is provided. The method of cleaning a liquid ejection head having a nozzle plate provided with a plurality of nozzles configured to eject a liquid, the method includes: a first step of filling an inside of a cap disposed to face a ejection surface of the nozzle plate provided with a nozzle opening with the liquid by driving a first piezoelectric element stacked on a diaphragm constituting a part of a pressure chamber communicating with the nozzle to eject the liquid from the nozzle; a second step of introducing air into the nozzle by driving the first piezoelectric element with a second drive signal different from the first drive signal after the first step; a third step of bringing the ejection surface into contact with the liquid in the cap after the second step; a fourth step of transmitting an ultrasonic wave to the liquid in the cap by driving a second piezoelectric element provided to the cap with a third drive signal after the third step; and a fifth step of sucking the liquid in the cap by driving a suction pump configured to suck the liquid in the cap after the fourth step. According to this aspect, when the ultrasonic wave is transmitted toward the nozzle plate to separate or float the foreign matter from the nozzle plate, the liquid in the pressure chamber and the liquid in the cap are separated by the air introduced into the nozzle. Accordingly, it is possible to reduce the possibility that the impact pressure due to the cavitation propagates to the pressure chamber through the liquid and high pressure is applied to the first piezoelectric element and the diaphragm. Therefore, it is possible to reduce the possibility that the first piezoelectric element and the diaphragm are damaged when the foreign matter is separated or floated from the nozzle plate using the ultrasonic wave.
(2) In the aspect described above, the first drive signal and the second drive signal may each be a signal configured to change a volume of the pressure chamber by driving the first piezoelectric element to deform the diaphragm, and the first drive signal and the second drive signal may be different from each other in a target period which is a period from a start of contraction of the pressure chamber to an end of expansion of the pressure chamber. According to this aspect, the vibration generated when the pressure chamber contracts can be amplified when the pressure chamber expands. Accordingly, the residual vibration of the pressure chamber can be increased. By increasing the residual vibration, the interface of the liquid in the nozzle opening is vibrated, and the air existing around the nozzle opening is drawn into the nozzle, so that the air can be introduced into the nozzle.
(3) In the aspect described above, defining a natural vibration period of the pressure chamber as Tc, the target period of the second drive signal may be shifted by Tc/2 from the target period of the first drive signal. According to this aspect, when the pressure chamber expands, it is possible to generate a vibration in the same phase as the vibration generated when the pressure chamber contracts. Accordingly, the vibration generated when the pressure chamber contracts and the vibration generated when the pressure chamber expands resonate with each other, and the vibration generated when the pressure chamber contracts can be further amplified when the pressure chamber expands. Therefore, since the residual vibration of the pressure chamber can be more reliably increased, air can be quickly introduced into the nozzle.
(4) In the aspect described above, in the fourth step, the second piezoelectric element may be driven in a state where the pressure chamber is expanded. According to this aspect, it is possible to transmit the ultrasonic wave to the liquid in the cap by driving the second piezoelectric element in a state where a small amount of the liquid is drawn into the nozzle due to the expansion of the pressure chamber, that is, in a state where the edge portion of the nozzle is immersed in the liquid. Accordingly, the foreign matter adhering to the edge portion can be more reliably separated or floated.
(5) According to another aspect of the present disclosure, there is provided a liquid ejection apparatus. The liquid ejection apparatus includes: a liquid ejection head including a nozzle plate provided with a plurality of nozzles each configured to eject a liquid, a pressure chamber communicating with the nozzle, a diaphragm constituting a part of the pressure chamber, and a first piezoelectric element stacked on the diaphragm; a cap disposed to face a ejection surface of the nozzle plate provided with a nozzle opening; a second piezoelectric element provided to the cap and configured to transmit an ultrasonic wave to the liquid in the cap; a suction pump configured to suck the liquid in the cap; and a controller configured to control drive of the liquid ejection apparatus, wherein the controller is configured to execute, in this order, first processing of filling an inside of the cap with the liquid by driving the first piezoelectric element with a first drive signal to eject the liquid from the nozzle, second processing of introducing air into the nozzle by driving the first piezoelectric element with a second drive signal different from the first drive signal, third processing of bringing the ejection surface into contact with the liquid in the cap, fourth processing of transmitting the ultrasonic wave to the liquid in the cap by driving the second piezoelectric element with a third drive signal, and fifth processing of sucking the liquid in the cap by driving the suction pump. According to this aspect, when the ultrasonic wave is transmitted toward the nozzle plate to separate or float the foreign matter from the nozzle plate, the liquid in the pressure chamber and the liquid in the cap are separated by the air introduced into the nozzle. Accordingly, it is possible to reduce the possibility that the impact pressure due to the cavitation propagates to the pressure chamber through the liquid and high pressure is applied to the first piezoelectric element and the diaphragm. Therefore, it is possible to reduce the possibility that the first piezoelectric element and the diaphragm are damaged when the foreign matter is separated or floated from the nozzle plate using the ultrasonic wave.
(6) In the aspect described above, the first drive signal and the second drive signal may each be a signal configured to change a volume of the pressure chamber by driving the first piezoelectric element to deform the diaphragm, and the first drive signal and the second drive signal may be different from each other in a target period which is a period from a start of contraction of the pressure chamber to an end of expansion of the pressure chamber. According to this aspect, the vibration generated when the pressure chamber contracts can be amplified when the pressure chamber expands. Accordingly, the residual vibration of the pressure chamber can be increased. By increasing the residual vibration, the interface of the liquid in the nozzle opening is vibrated, and the air existing around the nozzle opening is drawn into the nozzle, so that the air can be introduced into the nozzle.
(7) In the aspect described above, defining a natural vibration period of the pressure chamber as Tc, the target period of the second drive signal may be shifted by Tc/2 from the target period of the first drive signal. According to this aspect, when the pressure chamber expands, it is possible to generate a vibration in the same phase as the vibration generated when the pressure chamber contracts. Accordingly, the vibration generated when the pressure chamber contracts and the vibration generated when the pressure chamber expands resonate with each other, and the vibration generated when the pressure chamber contracts can be further amplified when the pressure chamber expands. Therefore, since the residual vibration of the pressure chamber can be more reliably increased, air can be quickly introduced into the nozzle.
(8) In the aspect described above, in the fourth processing, the controller may drive the first piezoelectric element to expand the pressure chamber, and may drive the second piezoelectric element in a state where the pressure chamber is expanded. According to this aspect, it is possible to transmit the ultrasonic wave to the liquid in the cap by driving the second piezoelectric element in a state where a small amount of the liquid is drawn into the nozzle due to the expansion of the pressure chamber, that is, in a state where the edge portion of the nozzle is immersed in the liquid. Accordingly, the foreign matter adhering to the edge portion can be more reliably separated or floated.
(9) In the aspect described above, the second piezoelectric element may be disposed at an outer surface of the cap at an opposite side to an inner surface facing the ejection surface. According to this aspect, the second piezoelectric element does not come into contact with the liquid in the cap. Therefore, the second piezoelectric element can be provided to the cap without requiring a member or a work for protecting the second piezoelectric element from the liquid.
(10) In the aspect described above, a signal generation circuit configured to generate the first drive signal, the second drive signal, and the third drive signal may further be provided. According to this aspect, the first piezoelectric element and the second piezoelectric element can be driven with different drive signals using a common circuit. Accordingly, since the circuit configuration for driving the piezoelectric elements can be simplified, the liquid ejection apparatus can be reduced in size, and the manufacturing cost of the liquid ejection apparatus can be reduced. Further, by using the common circuit, the liquid ejection head can be cleaned without detaching the liquid ejection head from the liquid ejection apparatus.

All of the plurality of components provided to each of the aspects of the present disclosure described above is not necessarily essential, and in order to solve some or all of the problems described above, or in order to achieve some or all of the advantages described in the specification, it is possible to make modification, elimination, replacement with other new components, partial deletion of the restriction content on some of the plurality of components. Further, in order to resolve some or all of the problems described above or achieve some or all of the advantages described in the specification, some or all of the technical features provided to one aspect of the present disclosure described above can be combined with some or all of the technical features provided to other aspects of the present disclosure described above to form an independent aspect of the present disclosure.

The present disclosure can be realized in various aspects other than the method of cleaning the liquid ejection head and the liquid ejection apparatus including the liquid ejection head and the cleaning apparatus of the liquid ejection head. The present disclosure can be realized in the aspects such as a method of manufacturing a liquid ejection apparatus, a method of controlling a liquid ejection apparatus, a computer program for realizing the control method, and a non-transitory recording medium on which the computer program is recorded.

What is claimed is:

1. A method of cleaning a liquid ejection head having a nozzle plate provided with a plurality of nozzles configured to eject a liquid, the method comprising:
filling an inside of a cap disposed to face an ejection surface of the nozzle plate provided with a nozzle opening with the liquid by driving a first piezoelectric element stacked on a diaphragm constituting a part of a pressure chamber communicating with the nozzle to eject the liquid from the nozzle;
introducing air into the nozzle by driving the first piezoelectric element with a second drive signal different from the first drive signal after the filling;
bringing the ejection surface into contact with the liquid in the cap after the filling;
transmitting an ultrasonic wave to the liquid in the cap by driving a second piezoelectric element provided to the cap with a third drive signal after the introducing; and
sucking the liquid in the cap by driving a suction pump configured to suck the liquid in the cap after the bringing.

2. The method according to claim 1, wherein
the first drive signal and the second drive signal are each a signal configured to change a volume of the pressure chamber by driving the first piezoelectric element to deform the diaphragm, and
the first drive signal and the second drive signal are different from each other in a target period which is a period from a start of contraction of the pressure chamber to an end of expansion of the pressure chamber.

3. The method according to claim 2, wherein
defining a natural vibration period of the pressure chamber as Tc, the target period of the second drive signal is shifted by Tc/2 from the target period of the first drive signal.

4. The method according to claim 1, wherein transmitting the ultrasonic wave includes driving the second piezoelectric element is driven in a state where the pressure chamber is expanded.

5. A liquid ejection apparatus comprising:
a liquid ejection head including a nozzle plate provided with a plurality of nozzles each configured to eject a liquid, a pressure chamber communicating with the nozzle, a diaphragm constituting a part of the pressure chamber, and a first piezoelectric element stacked on the diaphragm;
a cap disposed to face an ejection surface of the nozzle plate provided with a nozzle opening;
a second piezoelectric element provided to the cap and configured to transmit an ultrasonic wave to the liquid in the cap;
a pump configured to suck the liquid in the cap; and
a controller configured to control drive of the liquid ejection apparatus, wherein
the controller is configured to execute, in this order,
filling an inside of the cap with the liquid by driving the first piezoelectric element with a first drive signal to eject the liquid from the nozzle,
introducing air into the nozzle by driving the first piezoelectric element with a second drive signal different from the first drive signal,
bringing the ejection surface into contact with the liquid in the cap,
transmitting the ultrasonic wave to the liquid in the cap by driving the second piezoelectric element with a third drive signal, and
sucking the liquid in the cap by driving the suction pump.

6. The liquid ejection apparatus according to claim 5, wherein
the first drive signal and the second drive signal are each a signal configured to change a volume of the pressure chamber by driving the first piezoelectric element to deform the diaphragm, and
the first drive signal and the second drive signal are different from each other in a target period which is a period from a start of contraction of the pressure chamber to an end of expansion of the pressure chamber.

7. The liquid ejection apparatus according to claim 6, wherein
defining a natural vibration period of the pressure chamber as Tc, the target period of the second drive signal is shifted by Tc/2 from the target period of the first drive signal.

8. The liquid ejection apparatus according to claim 5, wherein
in the transmitting the ultrasonic wave, the controller drives the first piezoelectric element to expand the pressure chamber, and drives the second piezoelectric element in a state where the pressure chamber is expanded.

9. The liquid ejection apparatus according to claim 5, wherein
the second piezoelectric element is disposed at an outer surface of the cap at an opposite side to an inner surface facing the ejection surface.

10. The liquid ejection apparatus according to claim 5, further comprising
a signal generation circuit configured to generate the first drive signal, the second drive signal, and the third drive signal.
